(19) United States
(12) Patent Application Publication
(10) Pub. No.: US 2017/0054782 A1
(43) Pub. Date: Feb. 23, 2017

(54) OPTIMAL BUFFERING SCHEME FOR STREAMING CONTENT

(71) Applicant: Qualcomm Innovation Center, Inc., San Diego, CA (US)

(72) Inventors: Shirish Kumar Agarwal, Hyderabad (IN); Krishna V.S.S.S.R. Vanka, Hyderabad (IN); Sravan Kumar Ambapuram, Hyderabad (IN); Nikhil Kumar Kansal, Hyderabad (IN)

(21) Appl. No.: 14/831,223

(22) Filed: Aug. 20, 2015

(51) Int. Cl. H04L 29/06; H04L 29/08

(52) U.S. Cl. CPC H04L 65/605; H04L 67/06

(57) ABSTRACT

A method and apparatus for adjusting buffer size are provided. The method may comprise downloading a media file onto a media-player device, and then detecting, by the media-player device, the speed of the downloading. The method may further comprise transferring a first buffer packet of media content from the media file to a media processor. Then, the method may comprise providing and interrupt signal from the media processor, that indicated that the media content of first buffer packet has reached a lower media content threshold, and transferring, to the media processor, in response to the interrupt signal, one or more variably-sized buffer packets that are adjusted in size based on the speed of the downloading.

### TECHNICAL FIELD

Various embodiments described herein generally relate to media buffering schemes, and more particularly to dynamically scaling buffer sizes that are sent to media processors.

### BACKGROUND

Many types of internet-connected devices are capable of playing multimedia audio and video files. Such devices include smart phones, tablets, desktop computers, laptops, netbooks, entertainment systems, gaming systems, personal digital assistants (PDAs), wearable communication devices, etc. Increasingly, large audio and video files can be played on such devices through internet streaming, such that a file may be played as it is downloaded, and the file need not be permanently stored in non-volatile memory. A number of factors influence the quality of audio and video playback in terms of uninterrupted performance perceived by the user. A number of factors also influence the power consumption and battery life of the devices that play these media files. The factors that affect playback quality and power consumption include, among other things, the size of the file, the speed of the internet connection, and the capacity and quality of the media decoding and processing unit(s) in the device.

Many of these devices are capable of connecting to a variety of internet networks in a variety of ways. For example, laptops, desktops, gaming systems, and entertainment systems may be connected to a local area network (LAN) via an Ethernet cord or to a wireless local area network (WLAN) via a wireless router. Portable devices such as smartphones, laptops, tablets, entertainment systems, gaming systems, PDAs and wearables may be connected to cellular data networks, WLANs, ad hoc networks, or peer-to-peer networks via a variety of wireless transceivers. The speed at which a media file may be downloaded can vary according to the bandwidth available on the particular network to which a device is connected. Additionally, the speed may vary according to the strength of the wireless connection signal.

In all types of internet-connected devices that play streaming multimedia, it is preferable to provide an uninterrupted playback experience for the user, wherein there are few or no pauses in the playing of the file. Media buffering is well known in the art as a way to play files (either streaming or stored in non-volatile memory) while the files themselves are being downloaded. Such buffering involves the transfer of data packets to the media processor during the download. All modern multimedia consumers are familiar with delays and pauses in playback that result from the buffering process. These delays can be frustrating and lead to consumer dissatisfaction. Another consideration in portable, battery powered devices in particular, it that is preferable to reduce power consumption to extend battery life. The playback of large media files, and video files in particular, tends to consume large amounts of battery power, especially on smaller devices. As consumers continue to demand high multimedia performance and longer battery life, the current methods of media buffering have room for improvement, and will certainly become unsatisfactory in the future.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to an aspect of the disclosure, a method for adjusting buffer size is provided. The method may comprise downloading a media file onto a media-player device, and then detecting, by the media-player device, the speed of the downloading. The method may further comprise transferring a first buffer packet of media content from the media file to a media processor. Then, the method may comprise providing and interrupt signal from the media processor, that indicated that the media content of first buffer packet has reached a lower media content threshold, and transferring, to the media processor, in response to the interrupt signal, one or more variably-sized buffer packets that are adjusted in size based on the speed of the downloading.

In another aspect, the disclosure provides a media-player device, which may comprise a wireless transceiver configured to download media files at a rate of speed. The device may further comprise a media processor configured to process buffer packets, which itself comprises a lower media content threshold and an interrupter component configured to signal when the media processor has processed a buffer packet that has reached the low water mark. The device may also comprise an application core processor, which itself comprises an interruption detector component, and a dynamic buffer packet component configured to send two or more buffer packets of the media files to the media processor, wherein the two or more buffer packets are of varying sizes in relation to each other, and wherein a size of any of the two or more buffer packets is adjusted by the dynamic buffer component based on the rate of speed of the downloading of the media files.

Another aspect of the disclosure provides A non-transitory, tangible computer readable storage medium, encoded with processor readable instructions to perform a method for downloading a media file onto a media-player device and then detecting, by the media-player device, the speed of the downloading. The method may further comprise transferring a first buffer packet of media content from the media file to a media processor. Then, the method may comprise providing and interrupt signal from the media processor, that indicated that the media content of first buffer packet has reached a lower media content threshold, and transferring, to the media processor, in response to the interrupt signal, one or more variably-sized buffer packets that are adjusted in size based on the speed of the downloading.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a high-level system architecture of a media-player device in accordance with an aspect of the disclosure.

FIG. 2 is a flowchart depicting a method which may be traversed according to an aspect of the disclosure.

FIG. 3 is a diagram showing a process of transferring buffer packets between an application core processor and a media processor according to an aspect of the disclosure.

FIG. 4A is a pair of timelines depicting a chronological relationship between downloading and transferring buffer packets according to the prior art.

FIG. 4B is a pair of timelines depicting a chronological relationship between downloading and transferring buffer packets according to the prior art.

FIG. 5A is a pair of timelines depicting a chronological relationship between downloading and transferring buffer packets over a relatively fast download speed according to an aspect of the disclosure.

FIG. 5B is a pair of timelines depicting a chronological relationship between downloading and transferring buffer packets over a relatively slow download speed according to an aspect of the disclosure.

FIG. 6 is a timeline depicting a chronological relationship between downloading and transferring buffer packets over a very fast download speed according to an aspect of the disclosure.

FIG. 7A is a pair of timelines depicting a chronological relationship between downloading and transferring buffer packets over a variable slow download speed that gets faster over time, according to an aspect of the disclosure.

FIG. 7B is a pair of timelines depicting a chronological relationship between downloading and transferring buffer packets over a variable slow download speed that gets slower over time, according to an aspect of the disclosure.

### DETAILED DESCRIPTION

Various aspects are disclosed in the following description and related drawings to show specific examples relating to embodiments. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The terminology used herein describes particular embodiments only and should be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

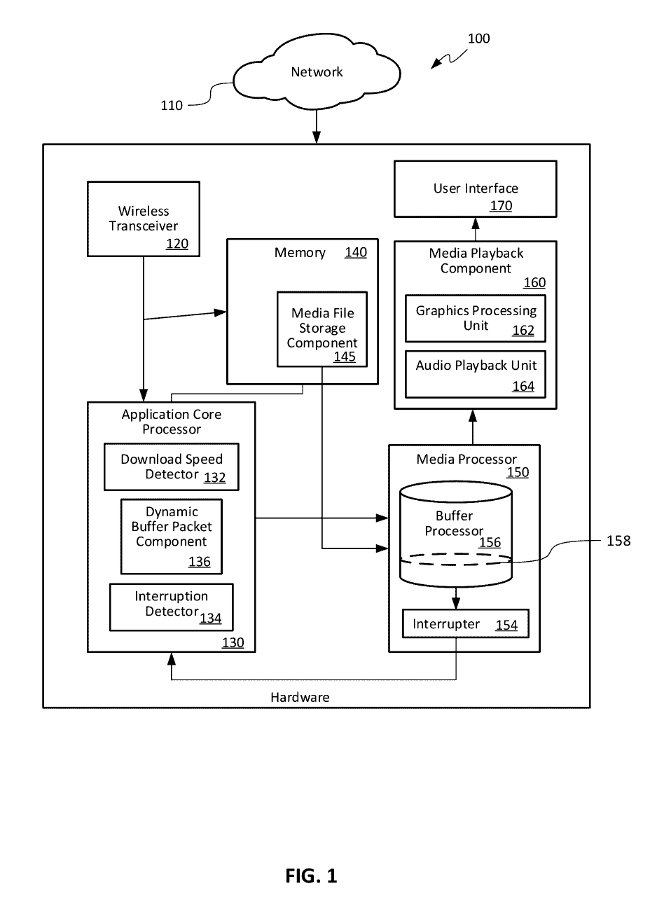

FIG. 1 depicts a high-level architecture of an internet-connected device capable of playing downloaded, streaming media 100. For simplicity, such a device shall be referred to as a “media player device” 100. The media player device 100 may be implemented as a variety of computing devices, such as a smart phone, tablet, laptop computer, desktop computer, entertainment system, gaming system, personal digital assistant (PDA), wearable device, or other similar device. Many of these types of devices may play multiple types of media, such as audio and video, and such devices may be referred to in the art as multimedia devices. However, some media player devices capable of performing embodiments of the present disclosure may only play one type of media file, such as audio. The media player device may be connected to a network 110, which may be implemented as a LAN, WLAN, a cellular data network such as 3G, 4G, “Long-Term Evolution” (LTE), an ad hoc or peer-to-peer network, or another type of network that can provide content from the internet. The media player device 100 may comprise a wireless transceiver 120. It is contemplated that in place of a wireless transceiver 120, a wired connection point to a network may be implemented instead. In such cases, a modem may replace the wireless transceiver. A wireless transceiver itself may also be known alternatively as a modem. For example, an Ethernet cable may be used to connect a desktop computer to a LAN in some embodiments of the present disclosure. However, because wireless connection technology continues to improve and is often more popular than wired connections, it is likely that most embodiments of this disclosure will comprise a wireless transceiver 120. The wireless transceiver 120 may be implemented by a WiFi transceiver, a cellular data transceiver, a Bluetooth transceiver, a satellite transceiver, GPS or SPS transceiver, etc. The wireless transceiver 120 may be used to download media files over the network 110.

The media files that may be downloaded by the wireless transceiver 120, and which will be referred to throughout this disclosure, may be in any one or more of various types of digital audio formats, including lossy or lossless, or compressed or uncompressed formats. Some common audio file formats include standards-based formats such as MP3 or MPEG-4/AAC, open source formats such as OGG Vorbis, ALAC, FLAC, and proprietary formats such as Apple Inc.'s® AIFF and Windows® WMA. Throughout this disclosure, media files and their corresponding playback may be referred to as “streaming.” The term “streaming,” as discussed herein, indicates that a media file and its associated playback have certain characteristics, i.e., that the file may begin playing prior to the completion of its download, that the data is not stored in persistent memory, and that the user has the experience of hearing or seeing the multimedia playback temporarily and not keeping the file. Common applications for streaming audio content include internet radio stations such as Pandora®, Spotify®, iTunes Radio®, and their competitors. Streaming audio content may also commonly be played through plugins or audio players on a web page within a web browser. For example, an audio music file may play automatically on certain websites when they are opened, or a link to a song may be embedded in a social media feed and play when clicked by a user.

The media files downloaded by the wireless transceiver 120 may also include video files for streaming video content. Such video files may be in formats including compressed or uncompressed types, standards-based, open source, or proprietary. Examples of some common video file formats can include MP4, MOV, WMV, FLV, and AVI. Common applications for streaming video content can include subscription-based mobile applications for watching television shows, movies, or sports, such as Hulu®, Netflix®, or WatchESPN®. Alternatively, streaming video content may be played through a dedicated video hosting website, such as YouTube® or Vimeo®. Also, streaming video content may be played through plugins or players for websites that are not dedicated for video hosting. For example, news sites and social media sites may have videos that play within the web page in the web browser.

In addition to audio and video files, media files downloaded by the wireless transceiver 120 may also include game files, which may themselves contain audio content, video content, and graphical animation content. There are hundreds of game file formats, including certain common types such as the .GAM, .NES, .ROM, and .SAV file formats. Online games that are streamed onto media player devices are immensely popular, and are often delivered using buffering data transmission and processing schemes. Aspects of the present disclosure can apply to any type of media file (in addition to the ones enumerated herein) that can be downloaded over a wireless transceiver and delivered to a processor in multiple buffer packets over time.

The wireless transceiver 120 may be connected to an application core processor 130 and a memory 140. The memory 140 may be implemented as, for example, Random Access Memory (RAM). The memory 145 may also comprise a media file storage component 145. The media file storage component 145 may temporarily store audio, video, and other types of files that are downloaded through the wireless transceiver 120 in a queue before they are transferred to a media processor 150. The media processor 150 will be described in more detail presently. The memory 140 and the application core processor 130 are depicted as connected by a logical bus to illustrate that the transfer of the downloaded media files from the memory 140 is controlled by the application core processor 130.

The application core processor 130 may also comprise a download speed detector 132. The download speed detector 132 may determine the rate of data transmission received from the network 110 by the wireless transceiver 120 at any given time. One way the download speed detector may determine the rate of data transmission is simply by measuring how much data is received into the memory 140 over a period of time. Another way the network speed detector 132 may determine the rate of data transmission is by simply detecting the type of wireless network connection that is being used for data transmission and estimating a default transmission rate. For example, the download speed detector 132 may detect that a 3G network is being used at a particular time, and may estimate the rate of data transmission to be between one to four Mbps (megabits per second). As another example, the download speed detector 132 may detect that a WiFi broadband connection is being used and estimate the download speed to be 25 Mbps. In other embodiments, the download speed detector 132 may more precisely determine the rate of data transmission by measuring recent downloads or by performing a speed test that requires some kind of communication with the network 110. Because the download speed is directly correlated to the network speed and connection, terms “download speed,” “network speed,” and “network connection” may be used interchangeably throughout this disclosure.

The application core processor 130 may also comprise an interruption detector 134, which can detect interrupt signals or transmissions from an interrupter component 154 within the media processor 150. The function of the interruption detector 134 will be described in more detail presently.

The media player device 100 may comprise a media processor 150. Though the term “media processor” is used throughout the disclosure, the term may also be used to refer to a multimedia processor. In many implementations, a media processor may comprise a media decoder. However, certain media files that comprise large amounts of encrypted data, such as e-books, may be processed by embodiments of the disclosure without a decoder. The media processor 150 may be implemented by a wide variety of audio decoders, video decoders, or combination audio/video decoders. Although audio and video decoders are referred to throughout this disclosure because audio and video files are ubiquitously consumed by users of today's most popular devices, the present disclosure is not limited to audio and video decoders only. In some embodiments, the media processor 150 may be implemented by another type of processor that renders files for presentation to the end user, such as a game file processor or a data file processor (for processing e-books or other digital documents, for example). For simplicity, audio and video decoders will be described most fully in this disclosure. In many embodiments, the media processor 150 may be implemented by a separate audio decoder and video decoder. There are several different types of audio decoders, but there is an enormous variety of video decoders. Throughout this disclosure, reference is made to the term “video decoder,” or “media processor,” but many other terms are commonly used in the art to describe processors with video decoding capabilities. Many of these decoders are also encoders of media data. The terms that encompass media processors include, for example, popular ones such as “codec” and “digital signal processor (DSP)”. For the purposes of this disclosure, a media processor can include any of the wide variety of codecs, DSPs, and similar processors that can process encoded media data for playback. Similarly, a media processor can include any audio or video decoder, or a combination of the two, that can process encoded audio or video data for playback.

The media processor 150 is depicted containing a buffer processor 156. The buffer processor 156 may not necessarily be a physical component, but is depicted to illustrate the concept of periodically receiving buffers from the media file storage component 145, the transfer of which is controlled by the application core processor 130. The buffer processor 156 is also used to depict that any given media processor 150 will have a maximum capacity buffer packet size it can accept at one time

In implementation, the buffer processor 156 and the media processor 150 may be the same hardware or software implemented in hardware. Furthermore, the terms “buffer processor” and “media processor” may be used interchangeably when appropriate. The term “buffer” is used in a variety of contexts in media digital signal processing, but for the purposes of this disclosure, the terms “buffer” and “buffer packet” are used to describe a portion of a media file that has been downloaded through the wireless transceiver 120, and which is transferred from the media file storage component 145 to the buffer processor 156 The functions of the media processor 150 and buffer processor 156 according to aspects of the present disclosure will be described in more detail shortly.

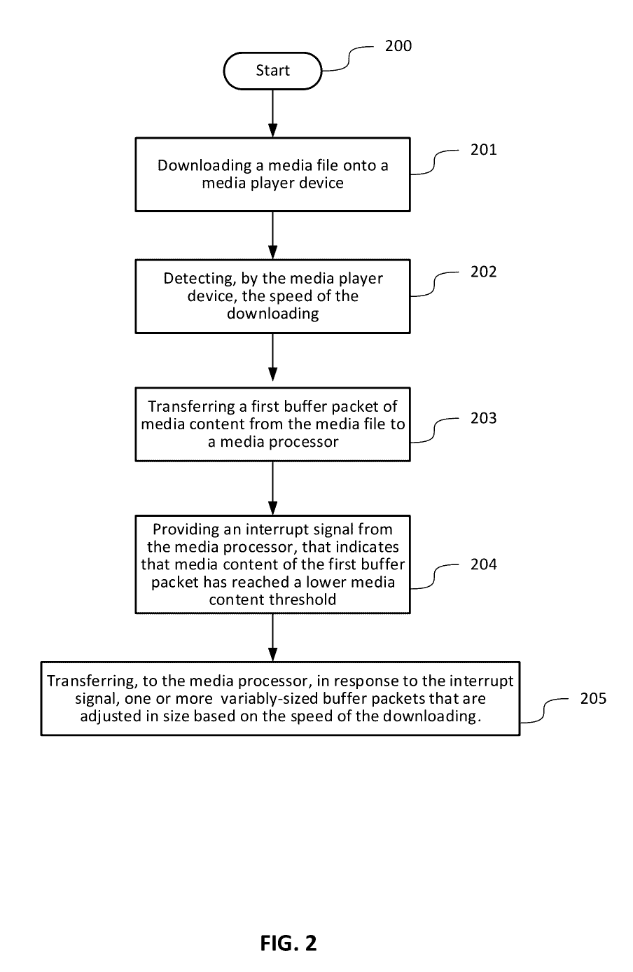

Aspects of the present disclosure will be described in relation to hardware components depicted in FIG. 1, and may also be described with reference to a method 200 depicted in FIG. 2, which may be carried out by components depicted in FIG. 1. For clarity, most of the components depicted in FIG. 1 will be described first before describing the method 200 in FIG. 2. Various processes described with reference to FIG. 1, and the method 200 in FIG. 2, may refer to a downloaded digital media file, which may comprise a “single” media file, such as a song or a video clip, with a defined beginning and end, which is broken up into buffer packets. Alternatively, a downloaded digital media file may comprise an audio or video signal that is continuously broadcast or streamed, such as an ongoing signal from an internet radio station or a television station. The term “downloaded” does not necessarily mean that a file is stored permanently and kept in non-volatile memory on a media player device. Additionally, it is known that digital files and signals typically go through some kind of transition to analog signals at various points during transmission, and the description of any files as “digital” should be understood to include their analog counterparts.

Once buffer packets have been processed by the buffer processor 156, the decoded media data is sent to a media playback component 160, which may contain a separate graphics processing unit 162 and an audio playback unit 164. Alternatively, the media playback component 160 may contain a single hardware element or software element implemented in hardware, rather than multiple elements. The media playback component 160 may interact with a user interface 170 to display or present the video or audio media in a form suitable for a user. The media playback component 160 may be a component of the user interface 170 itself in some embodiments. It is to be understood that the media playback component 160 and user interface 170 may be implemented by any number of components known in the art for presenting decoded media data to a user of a multimedia device.

Referring to the process of transferring buffer packets from memory to a media processor, in the prior art, a media file would be downloaded through a wireless transceiver at a particular rate, which would vary according to the network speed. Then, portions, or buffer packets, would be transferred to the media processor for decoding. These buffer packets have been of a fixed size in the prior art. That is, each time a buffer packet was sent to the media processor, it was the same size as all the other buffer packets sent for the particular file. The size of the buffer packets for a particular file has typically been dependent on characteristics of the file, such as whether it was an audio or video file, whether it contained mono clips, stereo clips, or multiple types of clips, or how many frames per second the video contained, among other factors. In addition to the characteristics of the file itself, the hardware of the multimedia device would also determine buffer packet size. For example, an application core processor might set a default rate for buffer packet size. Commonly, the media processor hardware itself would be used to determine buffer packet size. For example, a high-end media processor capable of decoding larger buffer packets quickly might cause the application core processor to set a large standard buffer packet size.

Also in the prior art, a media processor typically has a “low water mark,” which is an indication that the amount of encoded data remaining to be decoded has reached a low point, and that the media processor will need a new buffer packet soon in order to provide uninterrupted decoded data to a media playback component. The term “low water mark” is known in the art to indicate a measurement of a low level, and is not necessarily a physical component. A low water mark may be described in a more technical manner as a “lower media content threshold.” In the decoding of digital media files, the purpose of a low water mark if for a media processor to request new buffer packets at a particular point before it runs completely out of encoded data to decode. In FIG. 1, which depicts aspects of the present disclosure, the media processor 150 also has a low water mark 158, which is depicted as a line near the bottom of the buffer processor 156. It is contemplated that the low water mark 158 may be determined by a number of components or factors, such as by the hardware or software configuration of the media processor 150, characteristics of the media file, or the hardware or software configurations of other components of the media-player device 100. It is also contemplated that the low water mark 158 may vary from file to file.

Still referring to FIG. 1, the media processor has an interrupter 154, which is logically connected to buffer processor 156. The interrupter 154 sends an interrupter signal to the application core processor 130 when the level of data remaining to be decoded in the buffer processor 156 hits the low water mark 158. The interrupter signal sent by the interrupter 154 may take on different forms, but may generally be implemented as a transmission of a data packet or the generation of an electrical signal. The application core processor 130 may have a corresponding interruption detector 134 to receive the interrupter signal. The application core processor 130 may also comprise a dynamic buffer packet component 136, which can determine the size of the next buffer packet to be sent from the media file storage component 145 to the buffer processor 156. The dynamic buffer packet component 136 can also instruct the media file storage component to transfer the next buffer packet to the buffer processor 156 upon the detection of the interrupter signal from the interruption detector 134.

An aspect of the present disclosure is that the size of the buffer packets sent from the media file storage component 145 to the buffer processor 156 can be dynamic; i.e., that all the buffer packets associated with one particular download of a digital media file need not be the same size. Another aspect is that the buffer packet size can be based primarily on the network speed or on the download speed. In contrast to the prior art, wherein the buffer packet size was fixed, the present disclosure allows the buffer packet size to increase in size over time, or to remain fixed, or to decrease over time. In other words, a particular buffer packet may be variably-sized in relation to the packets that are transmitted before or after the particular buffer packet. Also in contrast to the prior art, the buffer packet size can be determined by the network speed or the download speed, rather than by the characteristics of the digital media file or the hardware of the application core processor or the media processor.

FIG. 2 is a flowchart depicting a method which may be traversed according to aspects of the disclosure. Simultaneous reference is made to components in FIG. 1. The wireless transceiver 120 may begin the download of a media file (e.g., a single audio, video, or game file, or a continuously broadcast audio, video, or game signal) (Block 201). The download speed detector 132 may then detect the speed of the downloading of the media file (Block 202).

In an embodiment of the disclosure, a first buffer packet of media content may be transferred from the media file storage component 145 to the buffer processor 156 (Block 203). The size of the first buffer packet may be determined by the minimum size required to start playback, as required by any components of the media player device 100. Alternatively, the size of the initial buffer packet may be determined by previously known methods, such as by clip characteristics. As another option, in some embodiments it is contemplated that the buffer packet size may be the size of the entire digital media file.

After the first buffer packet is sent to the buffer processor 156, the buffer packet is decoded, and when the amount of data from the buffer packet left to be decoded reaches the low water mark (also known as a lower media content threshold) 158, the interrupter 154 provides an interrupter signal (Block 204) to the interruption detector 134 to request a subsequent buffer packet. According to an aspect of the disclosure, the dynamic buffer packet component 136 determines the amount of data that has been downloaded and directs the transfer, to the media processor 150, of a second variably-sized buffer packet (Block 205). This second variably-sized buffer packet may be adjusted in size based on the speed of the downloading, as detected by the download speed detector 132. In many embodiments, the second variably-sized buffer packet may correspond to the size of all of the data that has been downloaded so far and is available in the media file storage component 145. It is contemplated that at the time that the interrupt signal is sent to the interruption detector 134, the amount of data from the downloaded digital media file may be much larger than the first buffer packet size. Therefore, the size of the second buffer packet may be much larger than the first buffer packet. The second buffer packet may then hit a low water mark, which then repeats the cycle of sending an interrupter signal and transferring another buffer packet. This process may be repeated until there are no more buffer packets left to be transferred.

It is contemplated that in many embodiments, the download of the digital media file through the wireless transceiver 120 and into the media storage component 145 may occur much faster than the rate at which the buffer packets are decoded and played back. It is also contemplated that any one particular media processor 150 and buffer processor 156 may decode buffer packets at a relatively fixed rate over time. Therefore, when a large buffer packet is sent to the buffer processor 156, a longer period of time may elapse before the amount of data remaining to be decoded in the buffer processor 156 hits the low water mark 158 and consequently sends an interrupt signal to the interruption detector 134.

An advantage to allowing dynamic buffer size based on download speed is that power savings may be achieved at several components within the multimedia device 100. In many embodiments, as will be depicted throughout this disclosure, sending dynamically sized buffer packets can result in the transmission of fewer buffer packets overall. When fewer, larger buffer packets are sent to the buffer processor 156, the data remaining to be decoded within the buffer processor will hit the low water mark less frequently, which in turn would cause the interrupter 154 to send fewer interrupt signals to the interruption detector 134. Each transmission of a buffer packet from the dynamic buffer packet component 136 of the application core processor 130, in conjunction with the media file storage component 145, requires some expenditure of power. The result of fewer transfers of buffer packets, then, is less power consumption by the application core processor 130. Similarly, each interrupt signal sent by the interrupter 154 of the media processor 150 requires some expenditure of power as well. When fewer, larger buffer packets are sent to the buffer processor 156, the low water mark 158 is hit less frequently and results in fewer interrupt signals, thereby resulting in less power consumption by the media processor 150.

In addition to saving power by sending fewer buffer packets and interrupt signals, the application core processor 130 and the media processor 150 can each save power by going into sleep modes for longer. Various components of application core processors in general, and media processors in general, enter sleep modes to save power. These sleep modes may be very brief. For example, some components may only sleep for a few milliseconds at a time. Nonetheless, sleep modes, wherein a processing component consumes no power, can be very valuable in terms of reducing power consumption, especially in portable multimedia devices that run on batteries. In embodiments of the present disclosure, the interrupter 154 of the media processor 150 can enter a sleep mode in between sending interrupt signals; generally, the larger the buffer packet being processed by the buffer processor 156, the longer the interrupter 154 can sleep. Similarly, the interruption detector 134 can sleep in between the detection of interrupt signals. Additionally, the dynamic buffer component 136 can sleep between the transmission of buffer packets to the buffer processor 156.

In some embodiments, power may also be saved by allowing the wireless transceiver 120 or modem to enter a sleep state. In some multimedia devices, the wireless transceiver 120 may keep an active network connection in response to activity on the part of the media processor 150. For example, if a media processor 150 is actively receiving buffer packets, or decoding buffer packets, the wireless transceiver 120 may remain alert for additional, related digital media files. In certain embodiments of the present disclosure, the media processor 150 may enter sleeping modes sooner or more frequently, which may in turn allow the wireless transceiver 120 to enter sleeping modes sooner or more frequently.

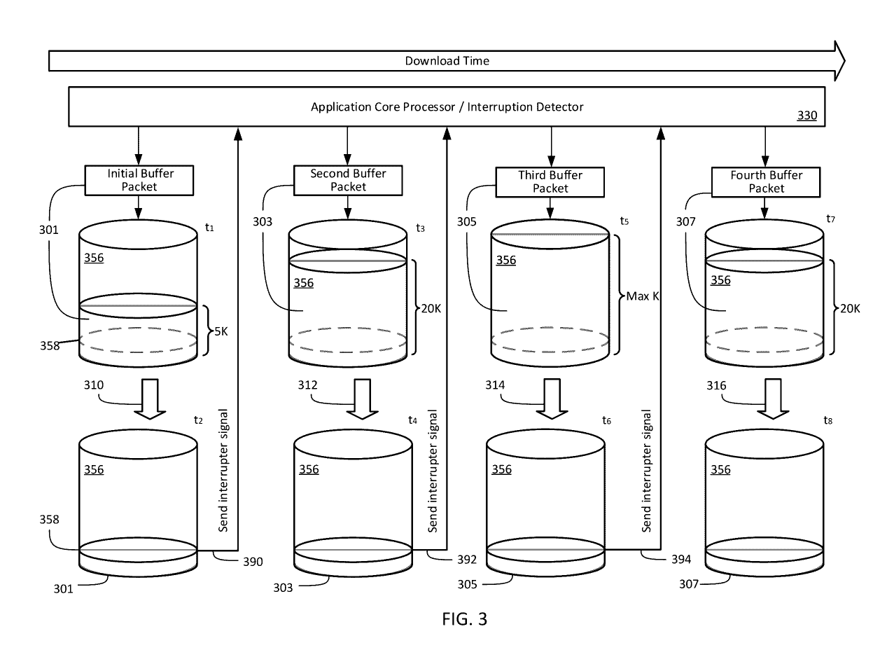

FIG. 3 illustrates how a buffer processor 356 may receive various sizes of buffer packets over time. The buffer processor 356 is shown at different times t₁ through t₈. The application core processor 330 sends an initial buffer packet 301, to the buffer processor 356 at t₁. Buffer packet 301 has a size of 5 KB, as an example. As discussed previously, the size of the initial buffer packet 301 may be determined in a number of ways, including being the minimum size necessary to begin media playback. The simple examples of buffer packet sizes in FIG. 3 are for illustrative purposes only, and the sizes of buffer packets may vary greatly depending on the application of the media processor. Additionally, the sizes of buffer packets may be expressed in a number of ways, such as by rates of transfer (Kbps or Mbps), data storage size (KB or MB), frames (FPS) or even processing speed (MIPS).

As shown in FIG. 3, the initial buffer packet 301 partially “fills” the buffer processor unit 356 at t₁. This visual depiction illustrates that the initial buffer packet 301 in this embodiment is less than the maximum buffer packet capacity of the buffer processor 356. The arrow 301 represents the decoding of the first buffer packet data. The buffer processor 356 at t₂ shows the initial buffer packet 301 hitting the low water mark 358. Once the low water mark 358 is hit, a first interrupter signal 390 is sent (by, for example, the interrupter 154 in FIG. 1, not depicted here) to the application core processor 330.

Still referring to FIG. 3, the application core processor 330 sends a second buffer packet 303 to the buffer processor 356 at t₃. In the example depicted, the second buffer packet 303 has a size of 20K. According to an embodiment of the disclosure, the size of the second buffer packet 303 can be 20K because 20K is all the available downloaded media data in the media file storage component 145 (depicted in FIG. 1) at the time of the first interrupter signal 390. Because the initial buffer packet 301 had a size 302 of 5K, and the second buffer packet 303 had a size 304 of 20K, a total of 25K had been downloaded at the time of the first interrupter signal 990. The arrow 312 represents the decoding of the second buffer packet. The buffer processor 356 at t₄ shows the second buffer packet 356 hitting the low water mark 358 at t₄. Once the low water mark 358 at t₄ is hit, the second interrupter signal 392 is sent to the application core processor 330.

The application core processor then sends a third buffer packet 305 to the buffer processor 356. The third buffer packet 305 can contain all the available downloaded media data in the media file storage component 145 (depicted in FIG. 1). In the example shown, the third buffer packet 305 has a size shown as the variable MaxK, which is the same size as the capacity of the buffer processor 356. It is contemplated that media processors in general have a maximum buffer packet size that they are capable of accepting. This maximum buffer packet size can vary greatly between media processors and can be determined by their hardware or software configurations. In the example shown, the buffer processor 356 at t₅ is shown at capacity with the third buffer packet 305 with size of MaxK, which is visually represented as slightly more than the second buffer packet 303 with size of 20K at t₃. However, the actual size of MaxK is not necessarily proportional to the size of 20K. That is, size of MaxK could be 100K, 25K, or any other value corresponding to the actual maximum capacity of the buffer processor 356.

Another aspect of the present disclosure is that the buffer packet size of any buffer packet after the first buffer packet will be the size of all available downloaded media data in the media file storage component, but that the buffer packet size may be limited by the capacity of a buffer processor or media processor. Referring back to FIG. 1, the dynamic buffer packet component 136 may take into account the maximum capacity of the buffer processor 156 in determining the size of the buffer packet to send. For example, if there are 500 KB of downloaded media data available in the media file storage component 145, but the maximum capacity of the buffer processor 156 is 240 KB, the dynamic buffer packet component 136 would send a buffer packet of 240 KB upon receiving an interrupter signal from the media processor 150.

Referring back to FIG. 3, the arrow 314 represents the decoding of the third buffer packet 305. Once the low water mark 358 is hit at t₆, an interrupter signal 394 is sent to the application core processor 303.

Upon receiving the third interrupter signal 394, the application core processor 330 may send a fourth buffer packet 307 to the buffer processor 356 at t7. The fourth buffer packet has a size of 20K in the example shown. The size 20K may be all of the available downloaded media data in the media file storage component 145 (depicted in FIG. 1.) According to an embodiment of the present disclosure, the fourth buffer packet has a size of 20K, which is smaller than the size of MaxK of the third buffer packet 356. It is contemplated that in some embodiments, all of the buffer packets will be the size MaxK after a certain number of buffer packets, because the digital media file may download completely before all of the buffer packets can be processed. However, in other embodiments, such as the one shown in FIG. 3, some of the buffer packets may be smaller than previous buffer packets, the reasons for which will be more clearly illustrated in later figures.

The arrow 316 represents the decoding of the fourth buffer packet 307. Once the low water mark is hit at t₈, another interrupter signal (not shown) may be sent to the application core processor 330. In the alternative, the fourth buffer packet may be the last buffer packet of the downloaded digital media file. In some embodiments, such as when the downloaded digital file is a continuous broadcast, the process depicted in FIG. 3 may continue with more buffer packets indefinitely.

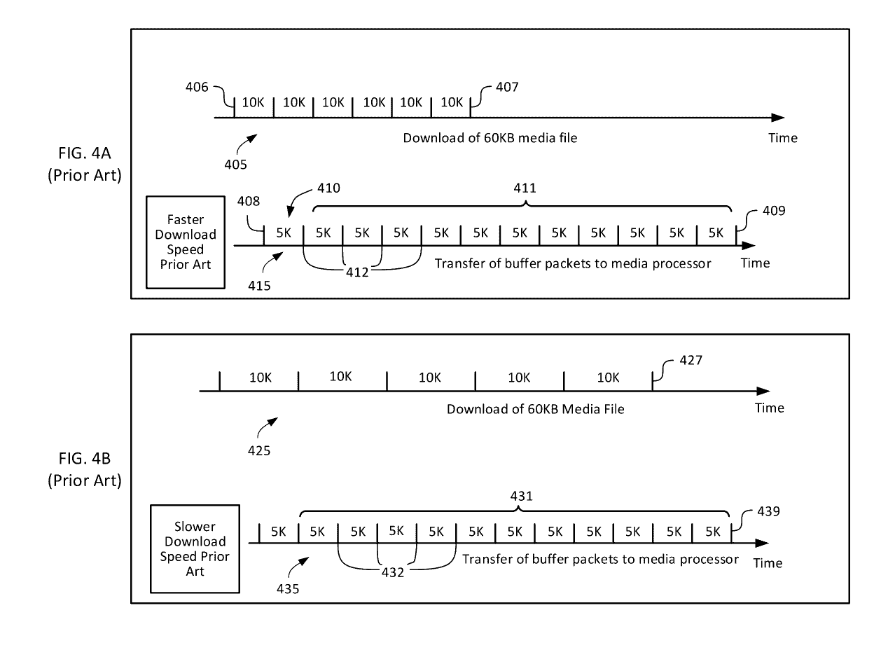

Turning now to FIGS. 4A and 4B, two sets of timelines are depicted to reflect the chronological relationship between downloaded media file and the transfer of buffer packets in the prior art. In FIG. 4A, the top timeline 405 shows the time it takes for a 60 KB media file to be downloaded over a “faster” download speed. The faster download speed may reflect a faster network connection. For example, FIG. 4A may have a broadband WiFi connection, but it is merely called “faster” in comparison to the “slower” network connection depicted in FIG. 4B, and the faster and slower network connections may be any network connections that are faster or slower as compared to each other. For example, FIG. 4A may represent a broadband WiFi connection while FIG. 4B represents a 4G wireless data connection. As another example, FIG. 4A may represent a wireless data LTE connection and FIG. 4B may represent a wireless data 3G connection. The timelines 405 and 415 of FIG. 4A and the timelines 425 and 435 of FIG. 4B represent concurrent periods of time, and represent the download and buffer packet transfers of the same file on the same type of media player device. That is, the only variable between the two timelines may be the network speed.

Referring specifically to the download timeline 405 of FIG. 4A, a download of a 60 KB media file begins at a start time 406 and ends at an end time 407. In the examples in FIG. 4A and subsequent figures, the sizes of media files and buffer packets will be referred to in terms of total storage space required for the file or packet, in terms of kilobytes (KB) and megabytes (MB). It is to be understood that the downloading or transferring of data may be commonly referred to in the art in terms of kilobits per second (Kbps), but for clarity and uniformity, the sizes of downloaded media data and buffer packets shall be referred to using KB and MB.

The download timeline 405 shows that a 60 KB media file is downloaded between the start time 406 and the end time 407. Although the 60 KB media file is shown evenly divided into units of 10 KB at a time, the download of the media file does not necessarily have to be divided into equal units, nor downloaded over a uniform rate over time.

The buffer packet timeline 415 of FIG. 4A shows that the transfer of buffer packets to a media processor begins at a start time 408 and ends at an end time 409. The start time 408 begins shortly after the start time 406 of the download timeline 405. Typically, a first buffer packet 410 will be sent once enough data has been downloaded to send a first buffer packet 410 that is a minimum size necessary to begin playback. Then, subsequent uniform buffer packets 411 of the same size will be sent to the media processor. In the example of FIG. 4A, each uniform buffer packet 411 is 5 KB in size. A uniform buffer packet size is known in the art, though it is not necessarily 5 KB. As each uniform buffer packet 411 is sent, an interrupter signal is sent once the buffer packet reaches the low water mark of the media processor, approximately represented at interrupt times 412. As seen in FIG. 4A, the download ends at end time 407, but the transfer of the uniform buffer packets 411, and the interrupter signals at each interrupt time 412 continue until end time 409.

Turning now to FIG. 4B, the download timeline 425 and the buffer transfer timeline 435 are similar to the download timeline 405 and the buffer transfer timeline 415 of FIG. 4A, except that the end time 427 of the download is later than the end time 407 of download timeline 405. That is, the same 60 KB file took longer to download over the slower network speed. However, the uniform buffer packets 431 of 5 KB each remained the same as uniform buffer packets 411 of FIG. 4A. Additionally, the interrupt signals were sent at interrupt times 432 at the same time and in the same way as interrupt times 412 of FIG. 4A. The transfer of the uniform buffer packets 431 also ends at end time 439, which is the same time as end time 409 of FIG. 4A.

In FIG. 4A, when the download speed is faster, six additional uniform buffer packets 411 and six interrupt signals are sent after the download end time 407. In FIG. 4B, two additional uniform buffer packets 431 and two interrupt signals are sent after the download end time 427.

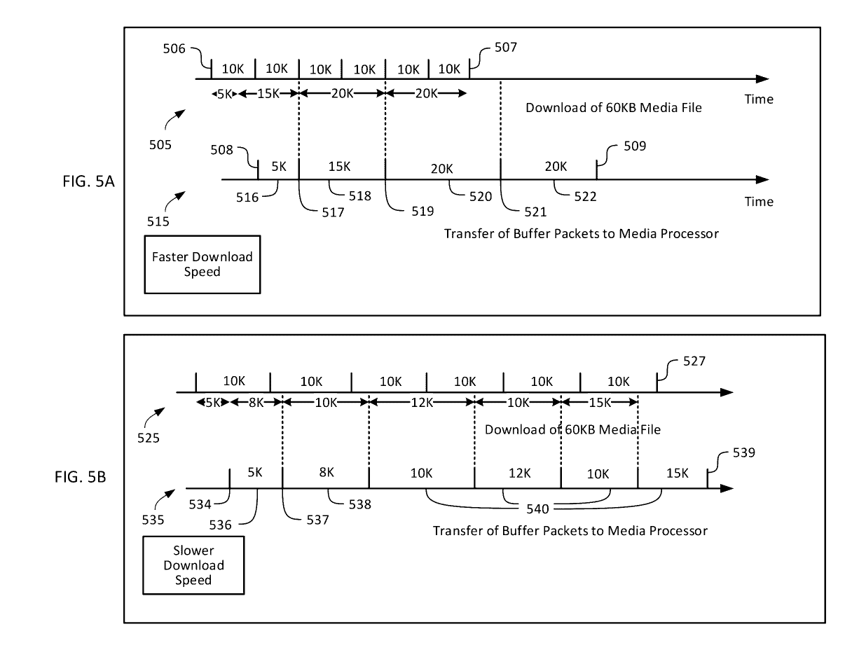

Turning now to FIGS. 5A and 5B, shown are two sets of timelines reflecting the chronological relationship between download times and buffer packet transfer times according to embodiments of the present disclosure. FIG. 5A shows download timeline 505 and buffer transfer timeline 515 at a faster download speed, and FIG. 5B shows download timeline 525 and buffer transfer timeline 353 at a slower download speed. The timelines 505 and 515 of FIG. 5A and the timelines 525 and 535 of FIG. 5B represent concurrent periods of time, and represent the download and buffer packet transfers of the same file on the same type of media-player device. That is, the only variable is the network speed. In contrast to the prior art depictions in FIGS. 4A and 4B, FIGS. 5A and 5B represent timelines of media-player devices such as the one depicted in FIG. 1, which dynamically change the buffer packet size according to the download speed.

In the download timeline 505, which starts at start time 506, a 60 KB media file is downloaded. The media file finishes downloading at end time 507. In the buffer packet transfer timeline 515, the transfer of the first buffer packet 516 begins at start time 508. The first buffer packet 516 in the example shown is 5 KB, and can represent the minimum amount required to start playback. In between the download start time 506 and the buffer packet transfer start time 508, 5K had been downloaded, and therefore 5K was transferred in the first buffer packet 516. At a first interrupt time 517, a first interrupt signal is sent, indicated by a dashed line. Between the start time 508 and the first interrupt time, 517, another 15 KB had been downloaded. Therefore, the second buffer packet 518 contains 15 KB. 15 KB is all the downloaded media data that is available to be transferred in a buffer packet at the time that the first interrupt signal was sent.

In some embodiments, media processors may process buffer packets at approximately similar rates. For example, a buffer packet that is 15 KB in size may take approximately three times as long to process as a buffer packet that is 5 KB in size. Furthermore, it is contemplated that the rate of processing may remain substantially constant even if the download rate changes.

In FIG. 5A, for example, the second buffer packet 518 is depicted as taking longer to process than the first buffer packet 516. Also, the rate at which data is downloaded over time in the download timeline 505 is greater than the rate at which data is transferred in the buffer transfer timeline 515.

At the second interrupt time 519, a second interrupt signal is sent, which is depicted as a dashed line at time 519. Between the first interrupt time 517 and the second interrupt time 519, an additional 20 KB had been downloaded. Therefore, the third buffer packet 520 contains 20 KB, which is all the downloaded media data that is available to be downloaded at the time the second interrupt signal was sent. At the third interrupt time 521, a third interrupt signal is sent. Between the second interrupt time 519 and the download end time 507, the final 20 KB of the media file had been downloaded. At the third interrupt time 521, the remaining 20 KB is sent as a fourth buffer packet 522. The 20 KB fourth buffer packet 522 represents all the downloaded media data that is available to be transferred at the time the third interrupt signal is sent, even though the third interrupt signal is sent after the download end time 507.

An advantage to sending dynamically sized buffer packets that adjust according to the download speed of the media file, rather than sending small fixed buffer packets, can be seen by comparing the number of transferred buffer packets and interrupt signals in FIG. 4A to FIG. 5A. In FIG. 4A, a 60 KB file with a fixed buffer packet size of 5K requires that twelve separate buffer packets and at least eleven separate interrupt signals be sent. In contrast, in FIG. 5A, a 60 KB file can be sent in four buffer packets with three interrupt signals. The reduction in the number of packets transmitted and signals sent can reduce power consumption.

FIG. 5B illustrates that dynamically sized buffer packets can also be used during slower download speeds to reduce the amount of power consumption. The download timeline 525 shows that the same 60 KB media file takes a longer time to download than the 60 KB file on the download timeline 505, as illustrated by the end time 527 occurring after the end time 507. The first buffer packet 536 has a size of 5K, which may be the minimum size required to begin playback. At the first interrupt time 537, a first interrupt signal is sent. Between the start time 534 and the first interrupt time 537, only an additional 8 KB has been downloaded. Therefore, the second buffer transfer packet 538 contains 8 KB. In contrast to the faster download timeline 505, where the first buffer transfer packet 516 contains 5 KB and the second buffer transfer packet 518 contains 15 KB, the second buffer transfer packet 538 is smaller due to the slower download speed reflected in download timeline 525. The buffer transfer timelines 515 and 535 may generally represent the same or similar media processors that process buffer packets are approximately the same rate, but to the extent that the depicted sizes of buffer packets are not to scale relative to each other, the difference in scale occurs for the ease of illustrative purposes only.

As depicted in FIGS. 5A and 5B, after the transfer of the second buffer packet 538, subsequent buffer packets 540 may be sent in a similar manner. That is, after every interrupt signal, the next buffer packet can be comprised of all of the media data downloaded since the previous buffer packet. As seen by the various sizes of the subsequent buffer packets 540, (i.e., 10K, 12K, 10K, and 15K) the sizes of the buffer packets may increase or decrease. In the example in FIG. 5B, this variation in buffer packet size can be due to small variations in the download speed. An aspect of the disclosure is that even though a slower network connection exists in FIG. 5B as compared to 5A, the implementation of dynamic buffer size still allows power savings when compared to fixed buffer size. For example, in FIG. 5B, six total buffer packets and five total interrupt signals are sent. Though these are greater numbers than the four buffer packets and three interrupt signals sent in FIG. 5A, they are less than they would be if a smaller fixed buffer size were used, such as the 5K buffer packets in FIGS. 4A and 4B. In the prior art, any fixed buffer packet sizes that are not tuned to the network speed must necessarily be small. Otherwise, if fixed buffers packets were set to be large, the transfer of the buffer packets might outpace the download speed. In order to receive another buffer packet, the media processor would have to wait until enough data was downloaded, potentially causing a delay in playback.

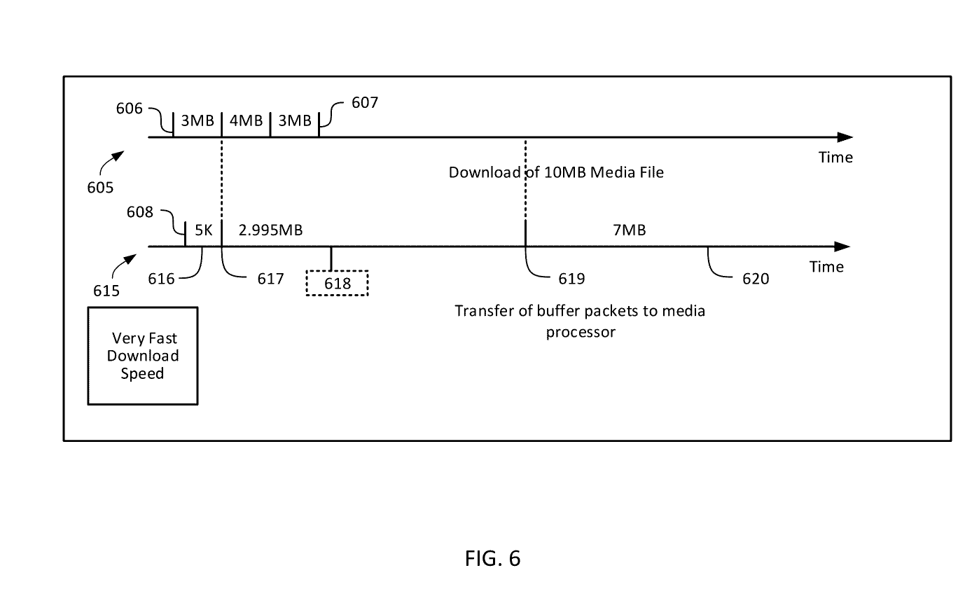

Turning now to FIG. 6, depicted is a pair of timelines showing the chronological relationship between the download time and the buffer transfer time according to another embodiment of the disclosure. FIG. 6 shows an example of a download over a very fast network speed as compared with FIGS. 5A and 5B, and with a robust media processor. FIG. 6 shows the download of a 10 MB file along download timeline 605 and the transfer of buffer packets along buffer transfer timeline 615. It is contemplated that in many embodiments, the download of a large file over a fast network connection may occur much more quickly than the buffer packets are decoded. For example, a large video file of 10 MB may be downloaded over a few seconds, but it may take several minutes to decode the buffer packets and play the video. In the example of FIG. 6, 10 MB is downloaded between the start time 606 and the end time 607. The transfer of the first buffer packet 616 of 5K occurs very shortly after the download begins, at start time 608. The size of the first buffer packet 616 may be determined, for example, by the minimum size needed to begin playback. During the time it takes the media processor to process the first buffer packet 616, approximately 3 MB has been downloaded. At the time 617 of the first interrupt signal, the available data to be transferred to the media processor is approximately 2.995 MB. Therefore, the size of the second buffer packet 618 is 2.995 MB. In the example of FIG. 6, the media processor has a maximum capacity of more than 2.995 MB, which allows the transfer of a large buffer packet. By the time 619 of the second interrupt signal, which is the time that the second buffer transfer packet 618 has been processed, the rest of the 10 MB file has been downloaded. The remaining media data available to be transferred is 7 MB, and therefore the third buffer packet 620 may be 7 MB in size. In the example of FIG. 6, the media processor has a maximum capacity of more than 7 MB, which allows the transfer of such a large buffer packet. An advantage to transferring large buffer sizes is that great power savings can be achieved when there is a fast network connection. In FIG. 6, only three total buffer packets are transferred, and only two interrupts signals are sent. If only small, fixed buffer sizes were sent, then hundreds of packets and interrupt signals would also have been sent.

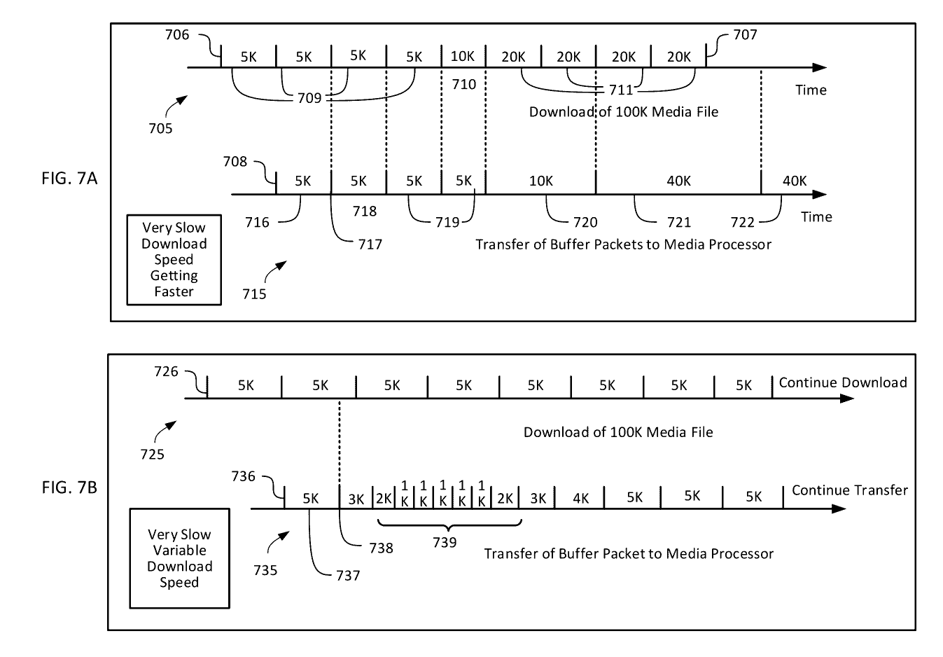

FIGS. 7A and 7B depict another aspect of the disclosure, and show two pairs of download timelines wherein the download speeds are very slow and variable, as compared to FIGS. 5A and 5B, wherein the download speeds are faster and somewhat constant. FIG. 7A shows an example of a download speed that begins slow, but gets faster. It depicts how the buffer packet sizes may vary according to aspects of this disclosure. In the example depicted, a 100 KB media file is downloaded between the start time 707 and end time 708 on the download timeline 705. The download begins slowly and gets much faster, as depicted by the first four segments of 5 KB 709 being downloaded over initial periods of time, and then a larger segment 710 of 10 KB and four larger sections 711 of 20 KB each being downloaded over similarly depicted periods of time. The download timeline 705 illustrates that 20 KB near the end of the timeline 705 can be downloaded in approximately the same amount of time that 5 KB was downloaded near the beginning of the timeline 705.

The buffer transfer timeline 715 illustrates how the buffer packet size may dynamically adjust to be attuned to the download speed. The first buffer packet 716 can be transferred as soon as the first 5 KB has been downloaded at start time 708. At the time 717 of the first interrupt signal, the second buffer packet 718 may be transferred, and it may also have a size of 5 KB, which reflects that the download speed is approximately the same as the buffer processing speed between start time 707 and first interrupt time 717. Similarly, the third and fourth buffer packets 719 are also 5K to reflect the download speed prior to their respective transfers. During the time it takes to process the fourth buffer packet 719, though, the download rate speeds up and 10 KB is downloaded. As a result, the fifth buffer packet 720 is 10 KB in size. Then, during the time it takes to process the fifth buffer packet 720, the download rate speeds up again and 40 KB is downloaded. As a result, the sixth buffer packet 721 is 40 KB in size. Before the sixth buffer packet 721 is finished processing, the final 40 KB is downloaded. Therefore, the final buffer packet 722 contains the final 40 KB. In this manner, another advantage to dynamically sized buffer packets that are attuned to network speed is apparent. Though several small, uniform buffer packets were sent while the download speed was slow, the buffer packets increased in size as the download speed increased, which resulted in fewer buffer packets and fewer interrupt signals toward the end of the download.

FIG. 7B depicts another aspect of the disclosure, by which the dynamic buffer packet size may improve playback performance during a slow download speed. The download timeline 725 shows the beginning of a download of a 100 KB media file over a very slow download speed that initially gets slower and then speeds up. The first buffer packet 737 is transferred at start time 736 of buffer transfer timeline 735, and is 5 KB in size. After the first buffer packet 737 is transferred, though, the download speed slows such that the first buffer packet 737 of 5 KB finishes processing before another 5 KB is downloaded. Therefore, at the first interrupt time 738, when the first interrupt signal is sent, only 3 KB is available to be transferred. As a result, the dynamic buffer packet component 136 of FIG. 1 adjusts the size of the second buffer packet 739 to be 3 KB. This smaller second buffer packet 739 may allow playback to continue uninterrupted. If the buffer size had been fixed at 5 KB, the buffer processor 156 (of FIG. 1) would have had to wait for an entire 5 KB to be downloaded. Therefore, at the first interrupt time 738, a buffer transfer packet would not have been available, which could have caused a pause in the playback. Such a scenario may occur in the prior art.

A further example of how buffer packets may be reduced in size according to an aspect of this disclosure is shown through the subsequent buffer packets 739. As the download speed remains low, the subsequent buffer packets 739 reduce in size from 2 KB to 1 KB. 1 KB may, for example, represent the smallest size a buffer packet may consist of because it may immediately hit the low water mark 158 (of FIG. 1). The transfer of minimally-sized buffer packets may allow playback to continue uninterrupted rather than pause while waiting for larger buffer packets. It is contemplated that there may be a lower limit to the size of the buffer packet and a corresponding limit to providing uninterrupted playback. That is, if the download speed slows too much, there may no media data to transfer at a particular interrupt time, and therefore the transfer of buffer packets may not occur at the particular interrupt time, pausing the playback.

Some example implementations are discussed above, but those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for adjusting buffer size, the method comprising;
downloading a media file onto a media-player device;
detecting, by the media-player device, the speed of the downloading;
transferring a first buffer packet of media content from the media file to a media processor;
providing an interrupt signal from the media processor that indicates that the media content of the first buffer packet has reached a lower media content threshold; and
transferring, to the media processor, in response to the interrupt signal, one or more variably-sized buffer packets that are adjusted in size based on the speed of the downloading.

2. The method of claim 1, wherein the one or more variably-sized buffer packets correspond in size to all media content available at the time of the interrupt signal.

3. The method of claim 1, further comprising;
providing one or more additional interrupt signals from the media processor, when the media content of the one or more variably-sized buffer packets has reached the lower media content threshold;
transferring, to the media processor, in response to the one or more additional interrupt signals, one or more subsequent variably-sized buffer packets after the one or more variably-sized buffer packets, wherein,
each of the one or more subsequent variably-sized buffer packets is transferred to the media processor in response to a signal indicating that a previous buffer packet has reached the lower media content threshold; and
each of the one or more subsequent variably-sized buffer packets corresponds to all of the downloaded media file available to be sent to the media processor at the time of the signal indicating that the previous buffer packet has reached the lower media content threshold.

4. The method of claim 1, wherein,
any of the one or more variably-sized buffer packets or the one or more subsequent variably-sized buffer packets are larger than the first buffer packet.

5. The method of claim 1, wherein,
the media file has a distinct beginning and end.

6. The method of claim 1, wherein,
the media file is one of a video file, an audio file, a game file, and an e-book file.

7. The method of claim 1, wherein,
the media processor comprises a digital signal processor.

8. The method of claim 3, wherein,
the size of the one or more variably-sized buffer packets and any of the one or more subsequent variably-sized buffer packets changes in relation to the speed of the downloading.

9. A media-player device, comprising;
a wireless transceiver configured to download media files at a rate of speed;
a media processor configured to process buffer packets, comprising;
a lower media content threshold, and
an interrupter component configured to signal when the media processor has processed a buffer packet that has reached the low water mark
an application core processor comprising;
an interruption detector component, and
a dynamic buffer packet component configured to send two or more buffer packets of the media files to the media processor, wherein the two or more buffer packets are of varying sizes in relation to each other, and wherein a size of any of the two or more buffer packets is adjusted by the dynamic buffer component based on the rate of speed of the downloading of the media files.

10. The media-player device of claim 9, further comprising;
a download speed detection component configured to determine the download speed of the media files, wherein the download speed detection component allows the dynamic buffer component to adjust the size of any of the two or more buffer packets.

11. The media-player device of claim 9, wherein;
the download speed detection component detects the speed of a network connection.

12. The media-player device of claim 8, wherein;
one or more of the wireless transceiver, the media processor, and the application core processor are configured to enter a sleep mode.

13. The media-player device of claim 8, wherein,
the two or more buffer packets comprise a first buffer packet and one or more subsequent variably-sized buffer packets, and any of the one or more subsequent variably-sized buffer packets is larger than the first buffer packet.

14. The media-player device of claim 8, wherein the media processor comprises a digital signal processor.

15. A non-transitory, tangible computer readable storage medium, encoded with processor readable instructions to perform a method for:
downloading a media file onto a media-player device;
detecting, by the media-player device, the speed of the downloading;
transferring a first buffer packet of media content from the media file to a media processor;
providing an interrupt signal from the media processor that indicates that the media content of the first buffer packet has reached a lower media content threshold; and
transferring, to the media processor, in response to the interrupt signal, one or more variably-sized buffer packets that are adjusted in size based on the speed of the downloading.

16. The non-transitory, tangible computer readable storage medium of claim 15, wherein the one or more variably-sized buffer packets correspond in size to all media content available at the time of the interrupt signal.

17. The non-transitory, tangible computer readable storage medium of claim 15, wherein the method further comprises:
providing one or more additional interrupt signals from the media processor, when the media content of the one or more variably-sized buffer packets has reached the lower media content threshold;
transferring, to the media processor, in response to the one or more additional interrupt signals, one or more subsequent variably-sized buffer packets after the one or more variably-sized buffer packets, wherein,
each of the one or more subsequent variably-sized buffer packets is transferred to the media processor in response to a signal indicating that a previous buffer packet has reached the lower media content threshold; and
each of the one or more subsequent variably-sized buffer packets corresponds to all of the downloaded media file available to be sent to the media processor at the time of the signal indicating that the previous buffer packet has reached the lower media content threshold.

18. The non-transitory, tangible computer readable storage medium of claim 15, wherein any of the one or more variably-sized buffer packets or the one or more subsequent variably-sized buffer packets are larger than the first buffer packet.

19. The non-transitory, tangible computer readable storage medium of claim 15, wherein the media file the media file has a distinct beginning and end.

20. The non-transitory, tangible computer readable storage medium of claim 15, wherein the media file is one of a video file, an audio file, a game file, and an e-book file.

21. The non-transitory, tangible computer readable storage medium of claim 17, wherein the size of the one or more variably-sized buffer packets and any of the one or more subsequent variably-sized buffer packets changes in relation to the speed of the downloading.
